(19) United States
(12) Patent Application Publication
(10) Pub. No.: US 2022/0172886 A1
(43) Pub. Date: Jun. 2, 2022

(54) INDUCTOR MANUFACTURING METHOD AND INDUCTOR

(71) Applicant: CHILISIN ELECTRONICS CORP., HSINCHU COUNTY (TW)

(72) Inventors: CHAO-YU CHIU, TAOYUAN CITY (TW); MING-CHIN TENG, TAOYUAN CITY (TW)

(21) Appl. No.: 17/512,642

(22) Filed: Oct. 27, 2021

(30) Foreign Application Priority Data
Nov. 30, 2020 (TW) 109141958

(51) Int. Cl. H01F 41/02; H01F 41/00; H01F 17/04; H01F 3/08

(52) U.S. Cl. CPC H01F 41/0246; H01F 41/005; H01F 2017/048; H01F 3/08; H01F 17/04

(57) ABSTRACT

An inductor manufacturing method and an inductor are provided. The inductor manufacturing method is used for manufacturing the inductor. The inductor includes a package body, a coil and two pins. The coil is located in the package body, the two pins are respectively connected to two ends of the coil, and parts of the two pins are exposed outside a bottom surface of the package body. The inductor manufacturing method includes: a pre-heating step including heating a core body; a core body placing step including placing the core body that is heated into a mold; a coil placing step including placing the coil into the mold; a powder filling step including filling a powder material into the mold; and a molding step including heating and pressing the mold, so that the powder material is molded into the package body.

### CROSS-REFERENCE TO RELATED PATENT APPLICATION

This application claims the benefit of priority to Taiwan Patent Application No. 109141958, filed on Nov. 30, 2020. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an inductor manufacturing method and an inductor, and more particularly to an inductor manufacturing method using a die-casting method and an inductor manufactured by the inductor manufacturing method.

### BACKGROUND OF THE DISCLOSURE

Reference is made to FIG. 1, in which a longitudinal section of an inductor manufactured by a conventional die-casting method is shown. A crack Z1 can be seen from the longitudinal section to be at the center of an inductor Z. The crack Z1 will directly or indirectly affect the characteristics of the inductor, such as permeability and inductance.

### SUMMARY OF THE DISCLOSURE

In response to the above-referenced technical inadequacies, the present disclosure provides an inductor manufacturing method and an inductor. The purpose of the present disclosure is mainly to improve a problem of cracking and other problems often found in a longitudinal section of an inductor manufactured by a conventional die-casting method.

In one aspect, the present disclosure provides an inductor manufacturing method for manufacturing an inductor. The inductor includes a package body, a core body, a coil and two pins. At least a part of the core body is located in the package body, the coil is located in the package body, the two pins are respectively connected to two ends of the coil, and parts of the two pins are exposed outside a bottom surface of the package body. The inductor manufacturing method includes: a pre-heating step including heating a core body; a core body placing step including placing the core body that is heated into a mold; a coil placing step including placing the coil into the mold; a powder filling step including filling a powder material into the mold; and a molding step including heating and pressing the mold, so that the powder material is molded into the package body.

In another aspect, the present disclosure provides an inductor manufactured by an inductor manufacturing method. The inductor includes a package body, a core body, a coil and two pins. At least a part of the core body is located in the package body, the coil is located in the package body, the two pins are respectively connected to two ends of the coil, and parts of the two pins are exposed outside a bottom surface of the package body. The inductor manufacturing method includes: a pre-heating step including heating a core body; a core body placing step including placing the core body that is heated into a mold and enabling a positioning structure at one end of the core body to be engaged with a positioning structure of a lower mold of the mold; a coil placing step including placing the coil into the mold; a powder filling step including filling a powder material into the mold; and a molding step including heating and pressing the mold, so that the powder material is molded into the package body. The positioning structure of the core body of the inductor is exposed outside the bottom surface of the package body.

Therefore, compared with a conventional inductor manufactured by the die-casting method, the inductor manufactured by the inductor manufacturing method of the present disclosure is less prone to cracks and other problems in a longitudinal section of the inductor.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a longitudinal section of an inductor manufactured by a conventional die-casting method;

FIG. 2 is a flowchart of an inductor manufacturing method according to a first embodiment of the present disclosure;

FIG. 3 is a perspective view of an inductor of the present disclosure;

FIG. 4 is a longitudinal section of the inductor of FIG. 3;

FIG. 5 is a perspective view of a lower mold and a core body of the inductor manufacturing method according to the present disclosure;

FIG. 6 is a flowchart of an inductor manufacturing method according to a second embodiment of the present disclosure;

FIG. 7 is a perspective view of a middle mold and the lower mold of the inductor manufacturing method according to the present disclosure;

FIG. 8 is a cross-sectional view of the middle mold and the lower mold of the inductor manufacturing method according to the present disclosure; and

FIGS. 9 to 13 are schematic diagrams corresponding to some steps of the inductor manufacturing method according to the second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

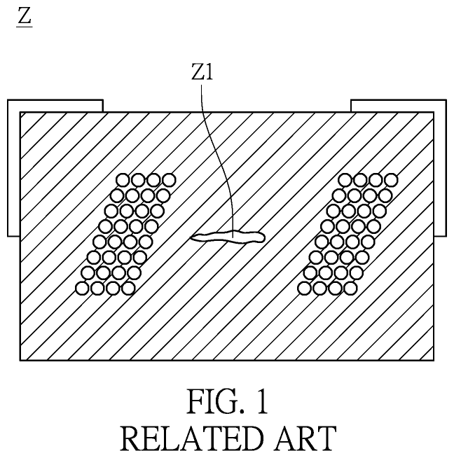

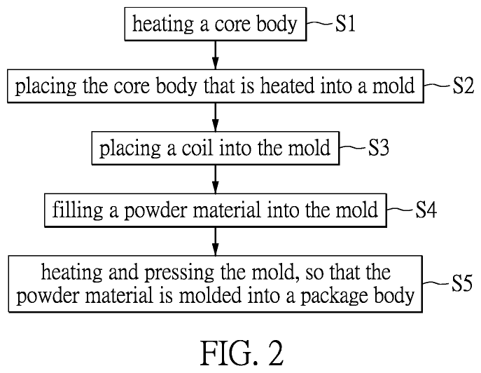

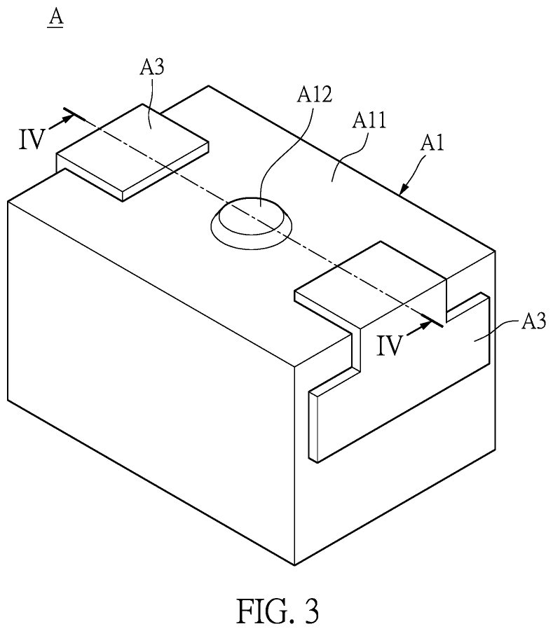

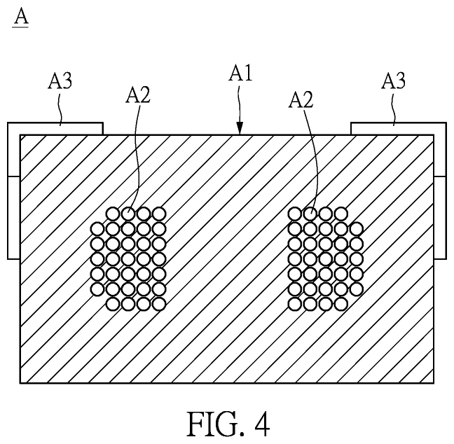

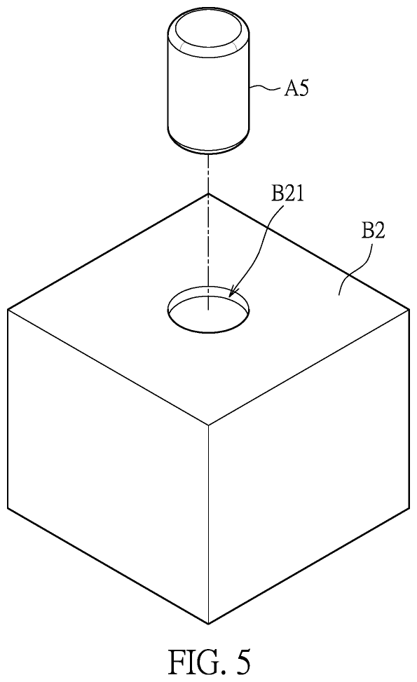

FIG. 1 is a longitudinal section of an inductor manufactured by a common die-casting method. Referring to FIG. 2 to FIG. 5, FIG. 2 is a schematic flowchart of an inductor manufacturing method according to a first embodiment of the present disclosure, FIG. 3 is a perspective view of an inductor of the present disclosure, FIG. 4 is a longitudinal section of the inductor of FIG. 3, and FIG. 5 is a perspective view of a lower mold and a core body of the inductor manufacturing method of the present disclosure.

The inductor manufacturing method of the present disclosure is used to manufacture an inductor A. The inductor A includes a package body A1, a coil A2 and two pins A3. The coil A2 is disposed in the package body A1. The two pins A3 are respectively connected to two ends of the coil A2, and parts of the two pins A3 are exposed outside a bottom surface A11 of the package body A1. The inductor manufacturing method includes the following steps.

A pre-heating step S1 includes heating a core body.

A core body placing step S2 includes placing the core body that is heated into a mold.

A coil placing step S3 includes placing the coil A2 into the mold.

A powder filling step S4 includes filling a powder material into the mold.

A molding step S5 includes heating and pressing the mold, so that the powder material is molded into the package body.

The core body can be a cylindrical structure, but the present disclosure is not limited thereto. The core body can also be a square columnar structure. The powder material can include a metallic-soft-magnetic powder and an adhesive glue. In an exemplary embodiment, a weight percentage concentration of the adhesive glue of the powder material is between 0.5 wt % and 10 wt %. Accordingly, the powder material can have better molding density and magnetic properties. The metallic-soft-magnetic powder can include, for example, carbon-based iron powder, reduced iron powder, atomized iron powder, iron-nickel powder, iron-silicon-aluminum powder, iron-silicon-chromium powder, iron-silicon powder, and the like. The adhesive glue can include, for example, epoxy resin, acrylic resin, phenol resin, silicone resin, and the like. In addition, the powder material may also include additives such as fatty acids of stearic acid and fluorinated graphite. In specific applications, the core body can also include the metallic-soft-magnetic powder, the core body and the powder material may be composed of the same material, and a density of the core body is greater than a density of the powder material. After the pre-heating step S1, part of the adhesive glue in the core body will escape, an overall hardness of the core body will be relatively increased, and tiny voids will be generated in the core body. Accordingly, in the molding step S5, the compressed core body will not be prone to cracks.

In practical applications, the pre-heating step S1 is to heat the core body to a first temperature, the molding step S5 is to heat the mold to a second temperature, and the first temperature is not greater than the second temperature. For example, the first temperature can be between 100 and 180 degrees Celsius (° C.), and the second temperature can be between 170 and 190 degrees Celsius (° C.). In a specific implementation, the core body can be heated in various ways, and the present disclosure is not limited thereto. For example, the core body can be disposed in an oven, and the core body can be heated by hot air baking.

In the core body placing step S2, for example, various robotic arm devices can be used to place the core body that is heated into the mold. It should be noted that, in the core body placing step S2, “the core body that is heated” can be, for example, a core body that has been heated and cooled to a normal temperature, or a core body that has just been heated and a temperature thereof has not yet cooled to the normal temperature. Naturally, “the core body that is heated” can also be a core body that has just been heated. Specifically, in an exemplary embodiment, a cooling step can be included between the pre-heating step S1 and the core body placing step S2, and the cooling step is to cool the heated core body to the normal temperature.

As shown in FIG. 5, in the core body placing step S2 of an exemplary embodiment, one end of a core body A5 can be engaged with a positioning structure B21 of a lower mold B2 of the mold, so that the core body A5 is stably set on the lower mold B2. For example, the core body A5 can be a columnar structure, and the positioning structure B21 of the lower mold B2 can be a corresponding groove. Naturally, in different embodiments, the positioning structure B21 of the lower mold B2 can also be a protruding structure, and the one end of the core body A5 can have a corresponding concave positioning structure.

It is particularly emphasized that, as long as the core body A5 can be stably set in the lower mold B2, shapes and sizes of the positioning structure of the core body A5 and the positioning structure B21 of the lower mold B2 can be changed according to requirements, and are not limited to those shown in the drawings of the present disclosure. In an exemplary embodiment, to enable the one end of the core body A5 to be easily set in the positioning structure B21 of the lower mold B2, the one end of the core body A5 can have a chamfer from 0.1 millimeters to 0.2 millimeters (mm).

By configuring the lower mold B2 to have the positioning structure B21, the core body A5 can be stably set on the lower mold B2, thereby preventing the core body A5 from skewing relative to the lower mold B2 during the manufacturing process. In the case where the core body A5 is less likely to skew, the coil A2 in the finally formed inductor A is also less likely to skew. As shown in FIG. 4, the coil A2 is arranged neatly in a longitudinal section of the inductor A made by the inductor manufacturing method of the present disclosure. In contrast, the coil A2 is arranged in a skewed manner in the longitudinal section of the inductor Z made by a conventional die-casting method as shown in FIG. 1. The coil A2 that is arranged in a skewed manner will directly or indirectly affect the relevant characteristics of the inductor A (such as inductance and magnetic permeability).

In the coil placing step S3, the coil A2 is sleeved on the core body A5, the two ends of the coil A2 can be respectively connected to two copper sheets, and parts of the two copper sheets will become the two pins A3 of the inductor A. In the powder filling step S4, a powder material A4 is filled in the mold, and the powder material A4 filled in the mold will cover the core body A5. However, a part of each of the copper sheets is not covered by the powder material A4. In the molding step S5, an upper mold B1 and the lower mold B2 having approximately the same temperature are jointly pressed against the powder material A4 and the core body A5 located in a middle mold B3 and the lower mold B2, so that the powder material A4 and the core body A5 are sintered into the package body A1.

As shown in FIG. 5, it is worth mentioning that, in an exemplary application, another end of the core body A5 away from the positioning structure B21 of the lower mold B2 may be a round chamfer with a radius from 0.1 millimeters to 0.2 millimeters (mm) Accordingly, after the one end of the core body A5 and the positioning structure B21 of the lower mold B2 are fixed to each other, the coil A2 can be fitted into the core body A5 in a relatively easy manner as a relevant personnel or equipment sets the coil A2 on the core body A5.

As described above, in the inductor manufacturing method of the present disclosure, portions of the adhesive glue in the core body A5 can escape through the pre-heating step S1, so that the hardness of the core body A5 is increased, and cracks do not easily appear in the longitudinal section of the finally produced inductor A. Specifically, as shown in FIG. 1, the conventional inductor manufactured by die-casting is prone to cracks at approximately the center position of the longitudinal section of the inductor. The inductor A manufactured by the inductor manufacturing method of the present disclosure will not easily crack at the center position of the longitudinal section of the inductor A.

It is worth mentioning that, as shown in FIG. 4, if the longitudinal section of the inductor A manufactured by the inductor manufacturing method of the present disclosure is viewed by the human naked eye, the core body and the cured powder material cannot be easily distinguished from each other, and what the human naked eye sees is the combined package body A1. Therefore, even if there is a relatively drastic temperature change in the environment in which the inductor is located, the package body A1 is not prone to failure due to thermal expansion and contraction of the material. Conversely, as shown in FIG. 1, in the longitudinal section of the inductor manufactured by the conventional die-casting method, a part surrounded by the coil and the remaining part located at a periphery of the coil can be easily distinguished from each other. There is a clear boundary between these two parts. When the environment of the inductor undergoes relatively drastic temperature changes, the part surrounded by the coil and the remaining part located at the periphery of the coil may cause the boundary to expand and crack due to factors such as different shrinkage rates or thermal expansion and contraction. As a result, the related characteristics (such as inductance and magnetic permeability) of the inductor are reduced during use.

### Second Embodiment

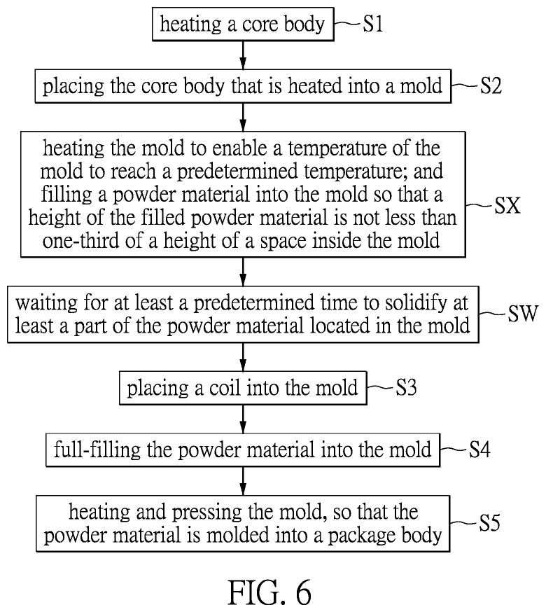

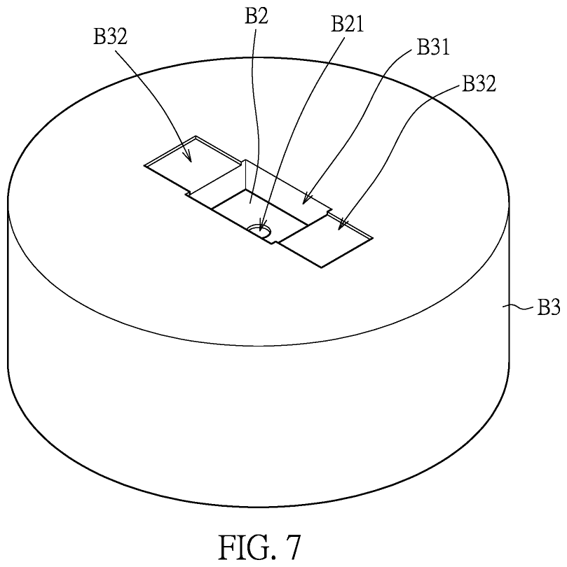

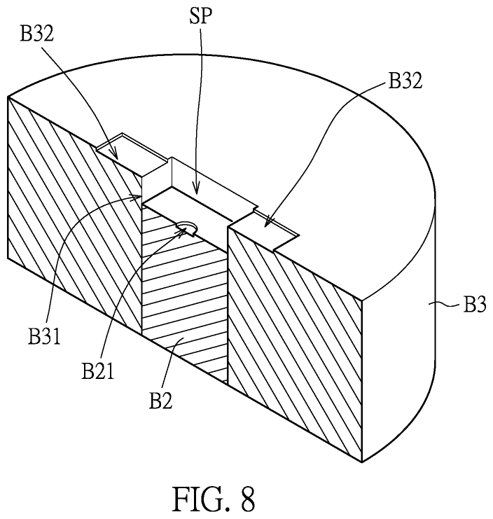

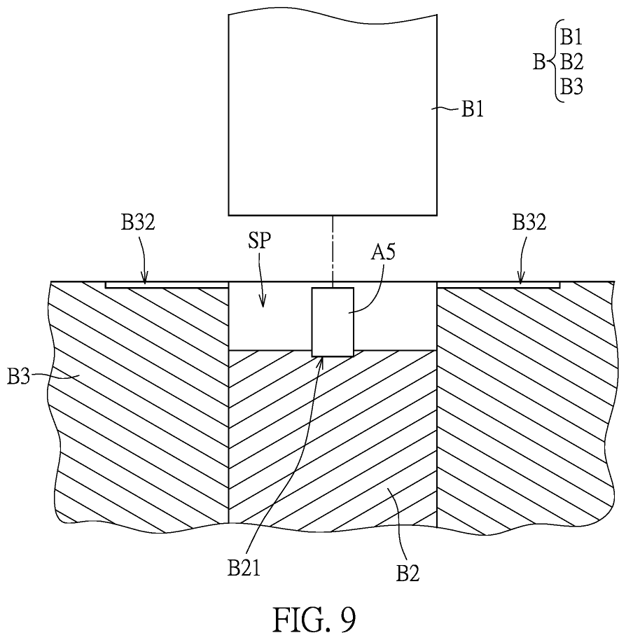

Referring to FIG. 6 to FIG. 13, FIG. 6 is a schematic flowchart of an inductor manufacturing method according to a second embodiment of the present disclosure, FIG. 7 is a perspective view of a middle mold and a lower mold of the inductor manufacturing method of the present disclosure, FIG. 8 is a cross-sectional view of the middle mold and the lower mold of the inductor manufacturing method of the present disclosure, and FIGS. 9 to 13 are schematic diagrams corresponding to some steps of the inductor manufacturing method according to the second embodiment of the present disclosure. As shown in FIG. 6, the inductor manufacturing method of the second embodiment includes the following steps.

A pre-heating step S1 includes heating a core body A5.

A core body placing step S2 includes placing the core body A5 that is heated into a mold B (as shown in FIG. 9).

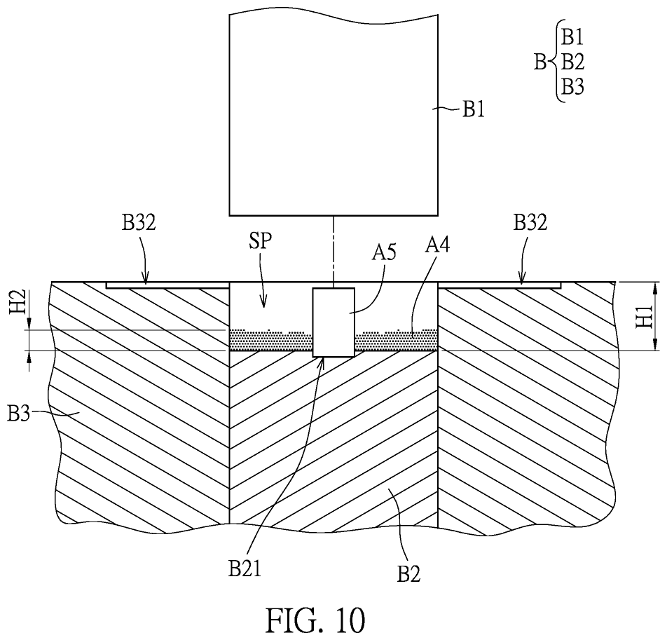

A pre-filling step SX includes heating the mold B such that a temperature of the mold B reaches a predetermined temperature; and filling a powder material A4 into the mold B, in which a height H2 of the filled powder material A4 is not less than one-third of a height H1 of a receiving space SP inside the mold B (as shown in FIG. 10).

A waiting step SW includes waiting for at least a predetermined time to solidify at least a part of the powder material A4 located in the mold B.

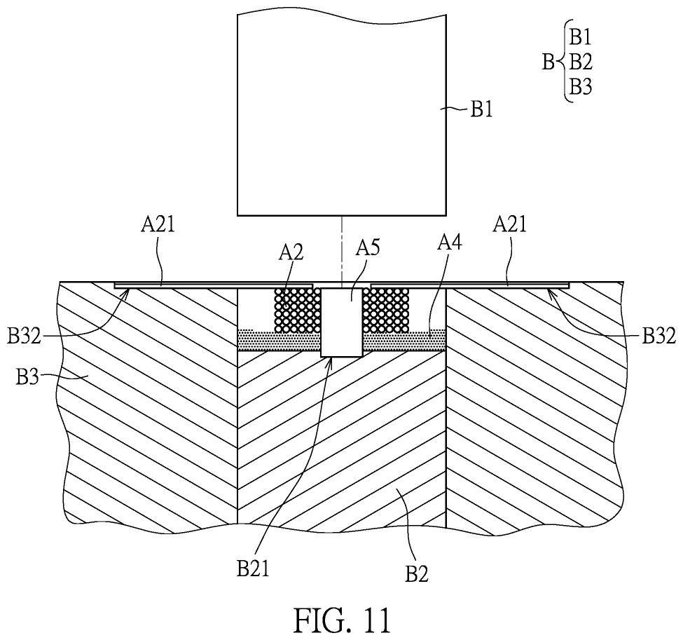

A coil placing step S3 includes placing a coil A2 into the mold B (as shown in FIG. 11).

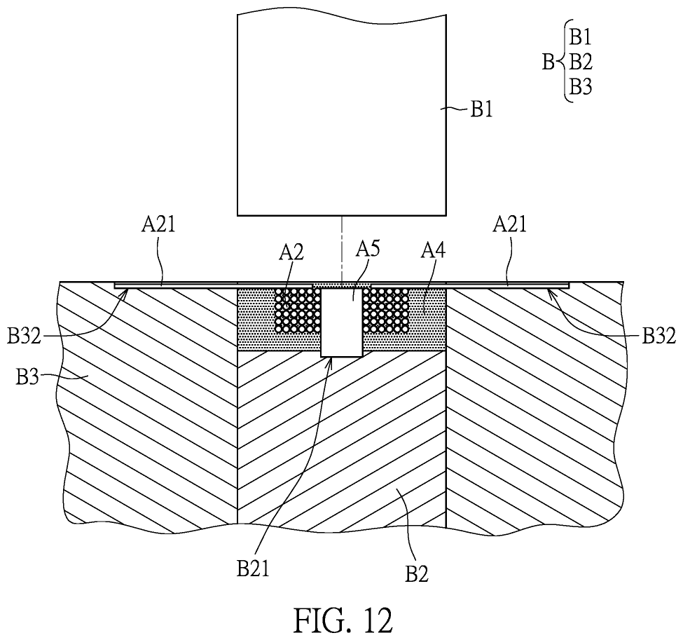

A powder filling step S4 includes filling up the mold B with the powder material A4 (as shown in FIG. 12).

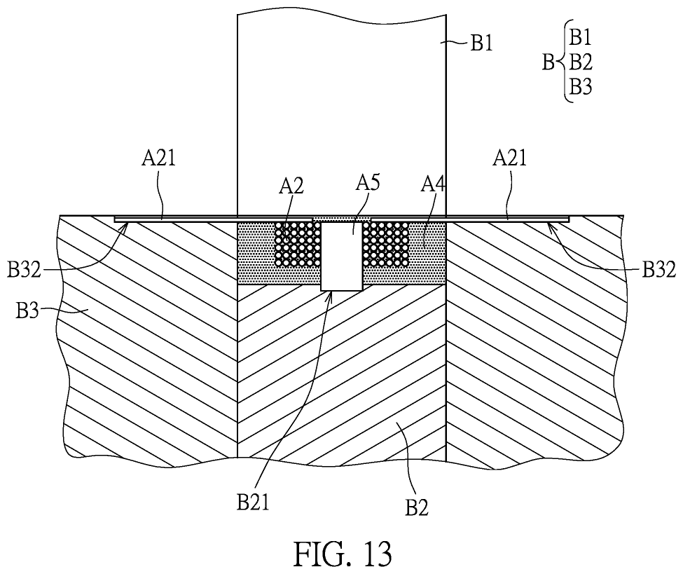

A molding step S5 includes heating and pressing the mold B, so that the powder material A4 is molded into a package body A1 (as shown in FIG. 13).

As shown in FIG. 7 to FIG. 9, the mold B may include an upper mold B1, a middle mold B3, and a lower mold B2. The middle mold B3 has a first groove B31 and two second grooves B32, a depth of the first groove B31 is greater than a depth of each of the second grooves B32, the first groove B31 is located between the two second grooves B32, and the first groove B31 communicates with the two second grooves B32. The lower mold B2 is disposed in the middle mold B3, and a positioning structure B21 is formed on a top surface of the lower mold B2. The top surface of the lower mold B2 and the first groove B31 of the middle mold B3 jointly form a receiving space SP, and the receiving space SP is used for receiving the powder material A4.

As shown in FIG. 9 and FIG. 10, the pre-heating step S1 refers to heating the middle mold B3 and the lower mold B2. Naturally, the upper mold B1 may also be heated at the same time. The core body placing step S2 is to engage one end of the core body A5 with the positioning structure B21 of the lower mold B2, and the core body A5 will be correspondingly located in the receiving space SP. The pre-filling step SX is to fill the powder material A4 into the receiving space SP.

As shown in FIG. 11, in the coil placing step S3, two conductive sheets A21 that are respectively connected to two ends of the coil A2 will be correspondingly disposed in the two second grooves B32. As shown in FIG. 12 and FIG. 13, in the powder filling step S4 and the molding step S5, the two conductive sheets A21 located in the two second grooves B32 will not be pressed by the upper mold B1. When the powder material A4 is formed into the package body A1, the two conductive sheets A21 will become two pins A3 after being appropriately bent.

In a specific implementation, the predetermined temperature referred in the pre-filling step SX can be between 100 and 180 degrees Celsius (° C.), and the predetermined time referred in the waiting step SW can be between 5 and 10 seconds. Naturally, the predetermined temperature and the predetermined time can be correspondingly changed according to the material of the powder, the size of the package body A1 (as shown in FIG. 3), and the like. In practical applications, the pre-filling step SX can be to heat the mold B and then fill the powder material A4 into the mold B. Alternatively, the powder material A4 can be filled into the mold B first, and then the mold B is heated.

By virtue of the designs of the pre-filling step SX and the waiting step SW, the core body A5 will be firmly set in the mold B through the cured powder material A4. In this way, the core body A5 will be less likely to be skewed in the subsequent steps. Correspondingly, the coil A2 sleeved on the core body A5 is not prone to problems such as skewing. In the longitudinal section of a finally produced inductor A (as shown in FIG. 4), the skewing problem of the coil A2 can be effectively improved.

As shown in FIG. 1, in the longitudinal section of an inductor made by a conventional die-casting method, cracks often appear at a part surrounded by the coil, and a part of the coil is often skewed due to irregular arrangements. The irregular or skewed coil arrangement will also directly or indirectly affect the characteristics of the inductor. In the above-mentioned inductor manufacturing method of the present disclosure, by virtue of the design of the lower mold B2 having the positioning structure B21 to fix the one end of the core body A5, or by virtue of the design of the pre-filling step SX and the waiting step SW, the finally produced inductor A will be relatively less prone to coil skewing or cracks in its longitudinal section (as shown in FIG. 4).

It is particularly emphasized that, as shown in FIG. 5, the core body A5 of the present disclosure has a columnar structure. By forming the positioning structure B21 in the lower mold B2, the core body A5 can be set upright in the lower mold B2. Furthermore, with the design of the pre-filling step SX and the waiting step SW, the core body A5 can be kept upright in the lower mold B2 during the subsequent steps, thereby ensuring that the coil A2 in the longitudinal section of the finally produced inductor A is less likely to skew.

In a certain embodiment of the present disclosure, the waiting step SW may be to incompletely solidify the powder material A4, and the coil placing step S3 may be to immerse part of the coil A2 into the powder material A4 filled in the mold B. Through the design of immersing the coil A2 in the powder material A4 filled in the mold B, the coil A2 can be set in the mold B more stably. Accordingly, in the longitudinal section of the finally produced inductor A, the coil A2 is less likely to be skewed.

It should be particularly noted that the appearance of the upper mold B1 shown in FIGS. 9 to 13 of the present embodiment is only one exemplary configuration. In practical applications, an end surface of the upper mold B1 facing the middle mold B3 may be concavely formed with a groove corresponding to the receiving space SP. The groove and the receiving space SP of the upper mold B1 can both be filled with the powder material A4, so as to form a package body with a specific appearance.

Referring to FIG. 3 to FIG. 5 again, FIG. 3 is a perspective view showing an inductor manufactured by the inductor manufacturing method of the present disclosure, and FIG. 4 is a longitudinal section of the inductor of FIG. 3. As shown in FIG. 3, the inductor A of the present disclosure includes the package body A1, the two pins A3, and a protruding structure A12. The coil A2 is disposed in the package body A1, and the two ends of the coil A2 are respectively connected to the two pins A3. A bottom surface A11 of the package body A1 has the protruding structure A12, and the protruding structure A12 is the part where the core body A5 and the positioning structure B21 are connected to each other (as shown in FIG. 5).

### Beneficial Effects of the Embodiments

In conclusion, in the inductor manufacturing method and the inductor provided by the present disclosure, cracks are less likely to appear and the coil is less likely to skew in the longitudinal section of the inductor. In addition, the inductor is not prone to failure during operation.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An inductor manufacturing method for manufacturing an inductor, the inductor including a package body, a coil and two pins, the coil being located in the package body, the two pins being respectively connected to two ends of the coil, parts of the two pins being exposed outside a bottom surface of the package body, and the inductor manufacturing method comprising:
a pre-heating step including heating a core body;
a core body placing step including placing the core body that is heated into a mold;
a coil placing step including placing the coil into the mold;
a powder filling step including filling a powder material into the mold; and
a molding step including heating and pressing the mold, so that the powder material is molded into the package body.

2. The inductor manufacturing method according to claim 1, further comprising a powder pre-filling step between the core body placing step and the coil placing step, wherein the powder pre-filling step includes filling the powder material into the mold; wherein, in the powder pre-filling step, a height of the powder material is not less than one third of a height of a space inside the mold, and the powder filling step is to fill up the mold with the powder material.

3. The inductor manufacturing method according to claim 2, wherein, in the powder pre-filling step, a temperature of the mold is heated to a predetermined temperature; wherein the inductor manufacturing method further includes a waiting step between the powder pre-filling step and the coil placing step, and the waiting step includes waiting at least for a predetermined time to solidify at least a part of the powder material that is filled in the mold.

4. The inductor manufacturing method according to claim 3, wherein, in the coil placing step, a part of the coil is submerged in the powder material that is filled in the mold.

5. The inductor manufacturing method according to claim 3, wherein the predetermined temperature is between 100° C. and 180° C.

6. The inductor manufacturing method according to claim 3, wherein the predetermined time is between 5 seconds and 10 seconds.

7. The inductor manufacturing method according to claim 1, wherein the pre-heating step is to increase a temperature of the core body to be between 100° C. and 180° C. by heating the core body.

8. The inductor manufacturing method according to claim 1, wherein the powder material includes a metallic-soft-magnetic powder and an adhesive glue, and a weight percentage concentration of the adhesive glue of the powder material is between 0.5 wt % and 10 wt %; wherein the core body includes the metallic-soft-magnetic powder, and a density of the core body is greater than a density of the package body.

9. The inductor manufacturing method according to claim 1, wherein, in the core body placing step, one end of the core body is connected to a positioning structure of a lower mold of the mold, and the core body is fixedly arranged on the lower mold through the positioning structure.

10. An inductor manufactured by the inductor manufacturing method as claimed in claim 9, wherein the bottom surface of the package body of the inductor has a protruding structure, and the protruding structure is a portion where the core body and the positioning structure are connected to each other.
